(19) United States
(12) Patent Application Publication
(10) Pub. No.: US 2026/0261851 A1
(43) Pub. Date: Sep. 3, 2026

(54) METHODS AND DEVICES FOR DETERMINING TARGET CELL ID FOR MAC-I CALCULATION

(71) Applicant: ZTE Corporation, Shenzhen (CN)

(72) Inventors: Wenting LI, Shenzhen (CN); Zhuang LIU, Shenzhen (CN); Jiajun CHEN, Shenzhen (CN)

(21) Appl. No.: 18/871,316

(22) PCT Filed: Aug. 8, 2022
(86) PCT No.: PCT/CN2022/110942

§ 371 Date: Dec. 3, 2024

(51) Int. Cl. H04W 12/06; H04W 12/106; H04W 76/19; H04W 84/04

(52) U.S. Cl. CPC H04W 12/06; H04W 12/106; H04W 76/19; H04W 84/042

(57) ABSTRACT

The present disclosure describes methods, system, and devices for determining a target cell identifier (ID) for calculating a message authentication code for integrity (MAC-I). One method includes determining, by a user equipment (UE), a target cell ID for calculating an authentication code corresponding to a cell by: receiving, by the UE, system information broadcasted from a network node; determining, by the UE, a network type of the cell based on the system information; and determining, by the UE, the target cell ID based on the network type and the system information. Another method includes determining, by a network node, a target cell ID for calculating an authentication code corresponding to a cell by: broadcasting, by the network node, system information to a UE; and determining, by the network node, the target cell ID based on a network type of the cell.

### CROSS-REFERENCE TO RELATED APPLICATION

This disclosure is a national stage filing under 35 U.S.C. § 371 of international application number PCT/CN2022/110942, filed on Aug. 8, 2022, the entire disclosure of which is incorporated herein by reference.

### TECHNICAL FIELD

The present disclosure is directed generally to wireless communications. Particularly, the present disclosure relates to methods and devices for determining a target cell identifier (ID) for calculating a message authentication code for integrity (MAC-I).

### BACKGROUND

Wireless communication technologies are moving the world toward an increasingly connected and networked society. High-speed and low-latency wireless communications rely on efficient network resource management and allocation between user equipment and wireless access network nodes (including but not limited to base stations). A new generation network is expected to provide high speed, low latency and ultra-reliable communication capabilities and fulfill the requirements from different industries and users.

A user equipment (UE) or a base station may need to determine a target cell identifier (ID) for calculating a message authentication code for integrity (MAC-I) during a UE resume or reestablishment procedure. There are some issue/problems associated with determining a target cell ID for MAC-I calculation, particularly for the network sharing scenario with the public network and non-public network.

The present disclosure describes various embodiments for determining a target cell ID for calculating a MAC-I, addressing at least one of the issues/problems discussed above. Various embodiments in the present disclosure may achieve low latency, low overhead, and short interruption time, thus, improving the efficiency and/or performance of the wireless communication.

### SUMMARY

This document relates to methods, systems, and devices for wireless communication, and more specifically, for determining a target cell identifier (ID) for calculating a message authentication code for integrity (MAC-I). The various embodiments in the present disclosure may be beneficial to reduce failures in MAC-I check, increase resource utilization efficiency, and to boost performance of the wireless communication.

In one embodiment, the present disclosure describes a method for wireless communication. The method includes determining, by a user equipment (UE), a target cell identity (ID) for calculating an authentication code corresponding to a cell by: receiving, by the UE, system information broadcasted from a first network node; determining, by the UE, a network type of the cell based on the system information; and determining, by the UE, the target cell ID based on the network type and the system information.

In one embodiment, the present disclosure describes a method for wireless communication. The method includes determining, by a first network node, a target cell identity (ID) for calculating an authentication code corresponding to a cell by: broadcasting, by the first network node, system information to a user equipment (UE); and determining, by the first network node, the target cell ID based on a network type of the cell.

In some other embodiments, an apparatus for wireless communication may include a memory storing instructions and a processing circuitry in communication with the memory. When the processing circuitry executes the instructions, the processing circuitry is configured to carry out the above methods.

In some other embodiments, a device for wireless communication may include a memory storing instructions and a processing circuitry in communication with the memory. When the processing circuitry executes the instructions, the processing circuitry is configured to carry out the above methods.

In some other embodiments, a computer-readable medium comprising instructions which, when executed by a computer, cause the computer to carry out the above methods.

The above and other aspects and their implementations are described in greater detail in the drawings, the descriptions, and the claims.

### BRIEF DESCRIPTION OF THE DRAWINGS

FIG. 1A shows an example of a wireless communication system include one wireless network node and one or more user equipment.

FIG. 1B shows a flow diagram of a user equipment (UE) transitioning from a radio resource control (RRC) inactive state to an RRC connected state.

FIG. 1C shows a flow diagram of a UE re-establishment procedure.

FIG. 2 shows an example of a network node.

FIG. 3 shows an example of a user equipment.

FIG. 4 shows a schematic diagram of a non-limiting embodiment for wireless communication.

FIG. 5A shows a flow diagram of a method for wireless communication.

FIG. 5B shows a flow diagram of another method for wireless communication.

FIG. 6 shows a schematic diagram of another non-limiting embodiment for wireless communication.

### DETAILED DESCRIPTION

The present disclosure will now be described in detail hereinafter with reference to the accompanied drawings, which form a part of the present disclosure, and which show, by way of illustration, specific examples of embodiments. Please note that the present disclosure may, however, be embodied in a variety of different forms and, therefore, the covered or claimed subject matter is intended to be construed as not being limited to any of the embodiments to be set forth below.

Throughout the specification and claims, terms may have nuanced meanings suggested or implied in context beyond an explicitly stated meaning. Likewise, the phrase “in one embodiment” or “in some embodiments” as used herein does not necessarily refer to the same embodiment and the phrase “in another embodiment” or “in other embodiments” as used herein does not necessarily refer to a different embodiment. The phrase “in one implementation” or “in some implementations” as used herein does not necessarily refer to the same implementation and the phrase “in another implementation” or “in other implementations” as used herein does not necessarily refer to a different implementation. It is intended, for example, that claimed subject matter includes combinations of exemplary embodiments or implementations in whole or in part.

In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B, or C, is intended to mean A, B, and C, here used in the inclusive sense, as well as A, B or C, here used in the exclusive sense. In addition, the term “one or more” or “at least one” as used herein, depending at least in part upon context, may be used to describe any feature, structure, or characteristic in a singular sense or may be used to describe combinations of features, structures or characteristics in a plural sense. Similarly, terms, such as “a”, “an”, or “the”, again, may be understood to convey a singular usage or to convey a plural usage, depending at least in part upon context. In addition, the term “based on” or “determined by” may be understood as not necessarily intended to convey an exclusive set of factors and may, instead, allow for existence of additional factors not necessarily expressly described, again, depending at least in part on context.

The present disclosure describes methods and devices for determining a target cell identifier (ID) for calculating a message authentication code for integrity (MAC-I).

Wireless communication technologies are moving the world toward an increasingly connected and networked society. High-speed and low-latency wireless communications rely on efficient network resource management and allocation between user equipment and wireless access network nodes (including but not limited to base stations). A new generation network is expected to provide high speed, low latency and ultra-reliable communication capabilities and fulfill the requirements from different industries and users.

Next generation (NG), or 5th generation (5G), wireless communication may provide a range of capabilities from downloading with fast speeds to support real-time low-latency communication. New generation (NG) mobile communication system are moving the world toward an increasingly connected and networked society.

A user equipment (UE) or a base station may need to determine a target cell identifier (ID) for calculating a message authentication code for integrity (MAC-I) during a UE resume or reestablishment procedure. There are some issue/problems associated with determining a target cell ID for MAC-I calculation, particularly for the network sharing scenario with the public network and non-public network. For example, in the network sharing scenario with the Public network, the UE may take a cell ID of a first public land mobile network (PLMN) as the target cell ID (TargetCellID) when calculating a short MAC-I for the radio resource control (RRC) resume or RRC reestablish procedure; for the networking sharing with only the non-public network, the cell ID of the first PLMN may be set randomly, leading to the unmatched short MAC-I and eventually resulting in a failure of the RRC resume or RRC reestablish procedure.

The present disclosure describes various embodiments for determining a target cell ID for calculating a MAC-I, addressing at least one of the issues/problems discussed above. Various embodiments in the present disclosure may achieve low latency, low overhead, and short interruption time, thus, improving the efficiency and/or performance of the wireless communication.

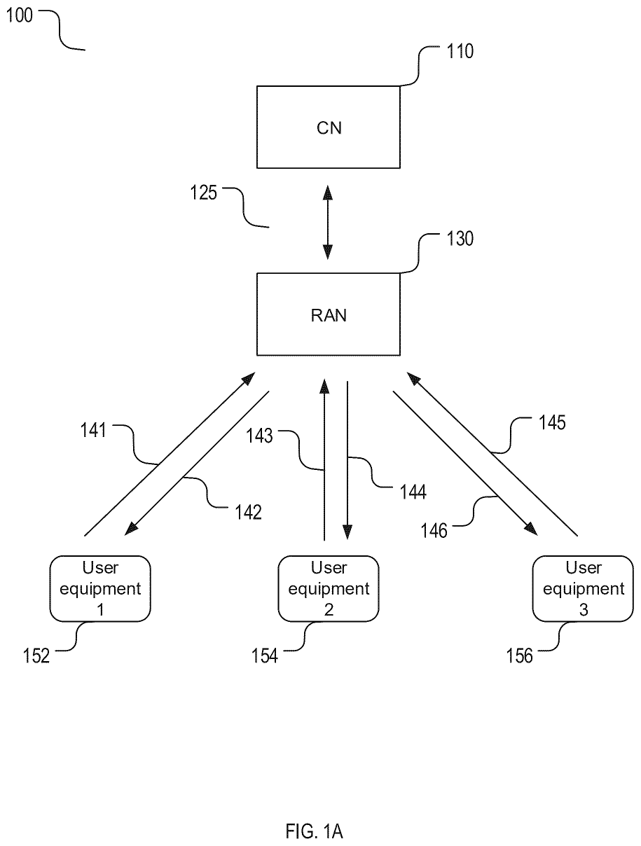

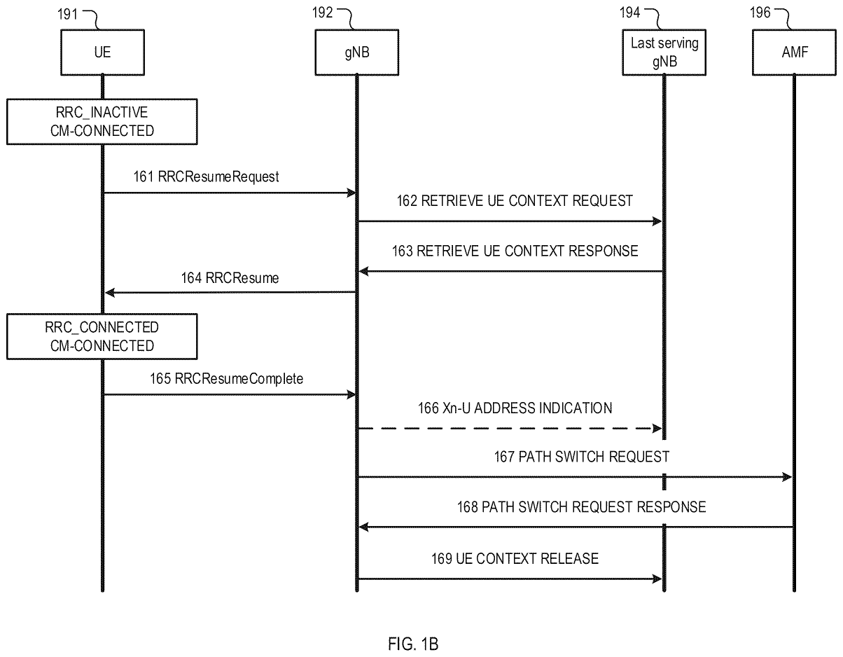

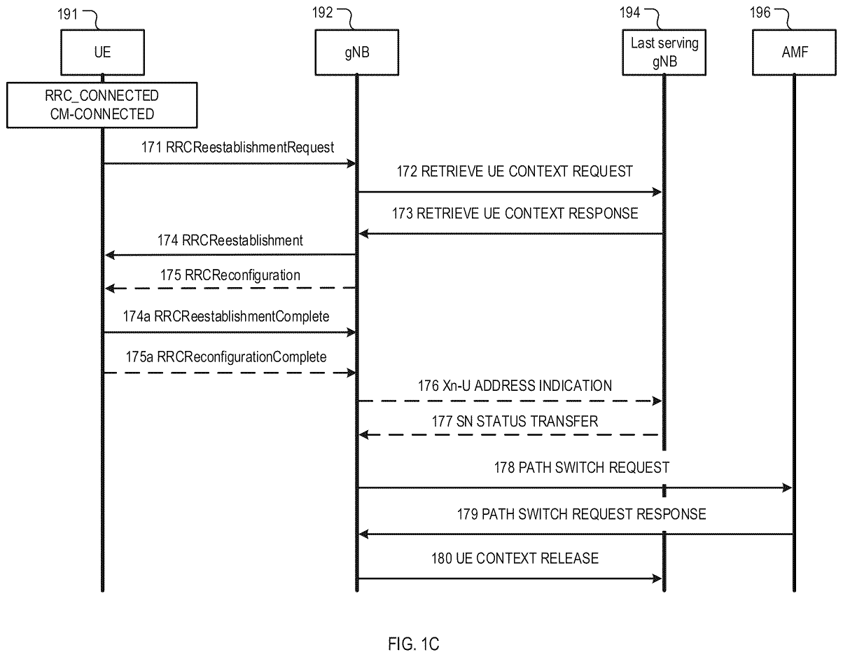

FIG. 1A shows a wireless communication system 100 including a core network (CN) 110, a radio access network (RAN) 130, and one or more user equipment (UE) (152, 154, and 156). The RAN 130 may include a wireless network base station, or a NG radio access network (NG-RAN) base station or node, which may include a nodeB (NB, e.g., a gNB) in a mobile telecommunications context. In one implementation, the core network 110 may include a 5G core network (5GC), and the interface 125 may include a new generation (NG) interface.

Referring to FIG. 1A, a first UE 152 may wirelessly receive one or more downlink communication 142 from the RAN 130 and wirelessly send one or more uplink communication 141 to the RAN 130. Likewise, a second UE 154 may wirelessly receive downlink communication 144 from the RAN 130 and wirelessly send uplink communication 143 to the RAN 130; and a third UE 156 may wirelessly receive downlink communication 146 from the RAN 130 and wirelessly send uplink communication 145 to the RAN 130. For example but not limited to, a downlink communication may include a physical downlink shared channel (PDSCH) or a physical downlink control channel (PDCCH), and an uplink communication may include a physical uplink shared channel (PUSCH) or a physical uplink control channel (PUCCH).

In some implementations with the new radio (NR) communication, referring to FIG. 1B, an inactive state of a UE (191) is used in which both the UE and the network, including a gNB 192, a last serving gNB 194, and an access and mobility function (AMF) 196, would keep part of the access stratum (AS) context and, when the UE need to resume the connection, the UE would send the resume request message to the network.

Some implementations may include a portion or all of the following steps. Referring to step 161, when the UE is in a RRC_inactive and connection management (CM)-connected state, the UE may send a RRCResumeRequest message to the gNB. Referring to step 162, the gNB may send a retrieve UE context request message to the last serving gNB. Referring to step 163, the last serving gNB may send a retrieve UE context response message to the gNB. Referring to step 164, the gNB may send a RRCResume message to the UE. In response to receiving the RRCResume message, the UE may enter a RRC_connected and CM-connected state. Referring to step 165, the UE may send a RRCResumeComplete message to the gNB. Referring to step 166, the gNB may send a Xn-U address indication to the last serving gNB. Referring to step 167, the gNB may send a path switch request message to the AMF. Referring to step 168, the AMF may send a path switch request response message to the gNB. Referring to step 169, the gNB may send a UE context release message to the last serving gNB.

In some implementations, the UE would include a short MAC-I in the resume request message in step 161.

For the reestablish procedure, referring to FIG. 1C, a similar MAC-I may be calculated and may be included in a Msg3 (e.g., RRC reestablish request message). At the network side, the gNB (or referred as “target gNB”) 192 would retrieve the UE context from the last serving gNB (or referred as “source gNB”) 194, and the source gNB would check the MAC-I first before sending the UE context to the target gNB.

Some implementations may include a portion or all of the following steps. Referring to step 171, the UE (in an RRC_connected and CM-connected state) may send a RRC reestablishment request message to the gNB. Referring to step 172, the gNB may send a retrieve UE context request message to the last serving gNB. Referring to step 173, the last serving gNB may send a retrieve UE context response message to the gNB. Referring to step 174, the gNB may send an RRC reestablishment message to the UE. Referring to step 175, the gNB may send an RRC reconfiguration message to the UE. Referring to step 174a, the UE may send an RRC reestablishment complete message to the gNB. Referring to step 175a, the UE may send an RRC reconfiguration complete message to the gNB. Referring to step 176, the gNB may send a Xn-U address indication to the last serving gNB. Referring to step 177, the last serving gNB may send an SN status transfer message to the gNB. Referring to step 178, the gNB may send a path switch request message to the AMF. Referring to step 179, the AMF may send a path switch request response message to the gNB. Referring to step 180, the gNB may send a UE context release message to the last serving gNB.

In some implementations, a short MAC-I calculation may include 3 inputs. For non-limiting example, the inputs (or referred as “VarResumeMAC-Input”) for calculating a resume short MAC-I may include a source physical cell identifier (PCI), a target cell identifier (ID), and/or a source cell radio network temporary identifier (C-RNTI).

In some implementations, at the network side, to retrieve the UE context, the target gNB may indicate the target cell ID information. For example, regarding the RRC resume, the new cell ID may correspond to the targetCellIdentity within the VarResumeMAC-Input or the cellIdentity within the VarShortINACTIVE-MAC-Input; regarding RRC reestablishment, the new cell ID may correspond to the targetCellIdentity within the VarShortMAC-Input or the cellIdentity within the VarShortMAC-Input; and/or regarding RRC resume for UP CIoT optimization, the new cell ID may correspond to the cellIdentity within the VarShortResumeMAC-Input or VarShortResumeMAC-Input-NB.

In some implementations, the source gNB/ng-eNB may obtain the target PCI and target ARFCN-DL/EARFCN-DL from a cell configuration database by means of the target Cell-ID which was received from the target gNB/ng-eNB. Considering the network sharing scenario, the cellIdentity of the first PLMN-Identity included in the PLMN-IdentityInfoList broadcasted in system information block 1 (SIB1) may be taken as the target cell. In some implementations, regarding targetCellIdentity (for the resume case), an input variable that is used to calculate the resumeMAC-I may be set to the cellIdentity of the first PLMN-Identity included in the PLMN-IdentityInfoList broadcasted in SIB1 of the target cell i.e. the cell the UE is trying to resume.

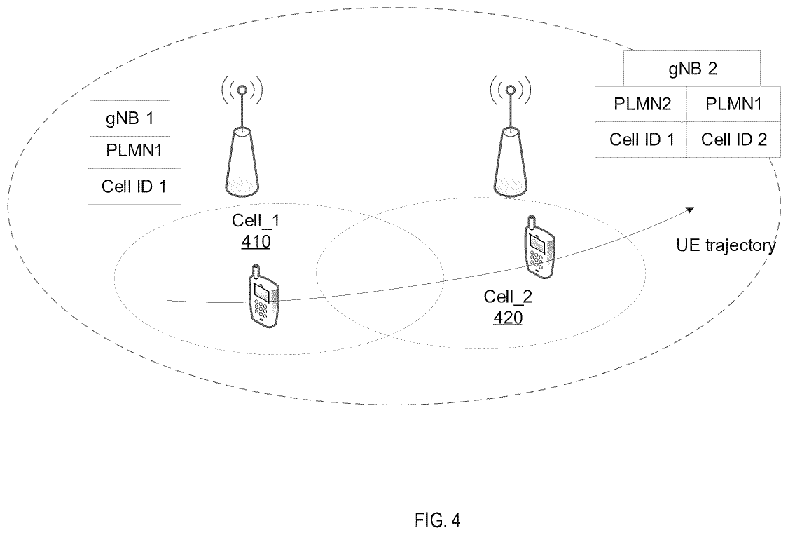

For a non-limiting example, in a public network sharing scenario, referring to FIG. 4, there may be two cells: Cell 1 (410): gNB1, broadcast PLMN 1, cell ID 1 in the SIB1; and Cell 2 (420): gNB2, broadcast PLMN 2, cell ID 1 and PLMN 1 cell ID 2 in the SIB1. When a UE moves from the Cell 1 to the Cell 2, the gNB 2 may set the PLMN 2, cell ID 1 as target Cell-ID. For the gNB 1, it may obtain the target PCI and target ARFCN-DL/EARFCN-DL from a cell configuration database by means of the combination of (PLMN 2, cell ID 1). In other words, when the gNB 1 can't get the correct PCI and the ARFCN, the context retrieve procedure may fail. Various embodiments in the present disclosure may address the issue of failure described above.

In some implementations, besides the public network, the non-public network may be specified: there are two private network types: stand-along non-public network (SNPN) and the public network integrated non-public network (PNI-NPN). For a SNPN only cell, the network may broadcast a dummy PLMN to the legacy public network ID list. Similarly, for a PNI-NPN only cell, the network may broadcast a forbidden PLMN to the legacy public network ID list. In other words, the cell access information for the legacy public part may be invalid for the NPN-only cell. Thus, when the UE need to resume/reestablish the connection with the NPN-only cell, there may be some problems when it still takes the first cell ID of the PLMN network as the target cell ID. Various embodiments in the present disclosure may address the problem(s) described above.

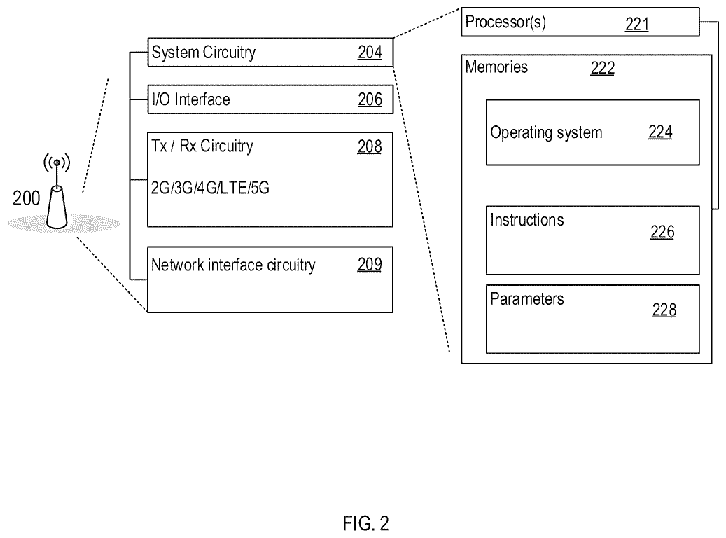

FIG. 2 shows an exemplary a radio access network or a wireless communication base station 200. The base station 200 may include radio transmitting/receiving (Tx/Rx) circuitry 208 to transmit/receive communication with one or more UEs, and/or one or more other base stations. The base station may also include network interface circuitry 209 to communicate the base station with other base stations and/or a core network, e.g., optical or wireline interconnects, Ethernet, and/or other data transmission mediums/protocols. The base station 200 may optionally include an input/output (I/O) interface 206 to communicate with an operator or the like.

The base station may also include system circuitry 204. System circuitry 204 may include processor(s) 221 and/or memory 222. Memory 222 may include an operating system 224, instructions 226, and parameters 228. Instructions 226 may be configured for the one or more of the processors 124 to perform the functions of the base station. The parameters 228 may include parameters to support execution of the instructions 226. For example, parameters may include network protocol settings, bandwidth parameters, radio frequency mapping assignments, and/or other parameters.

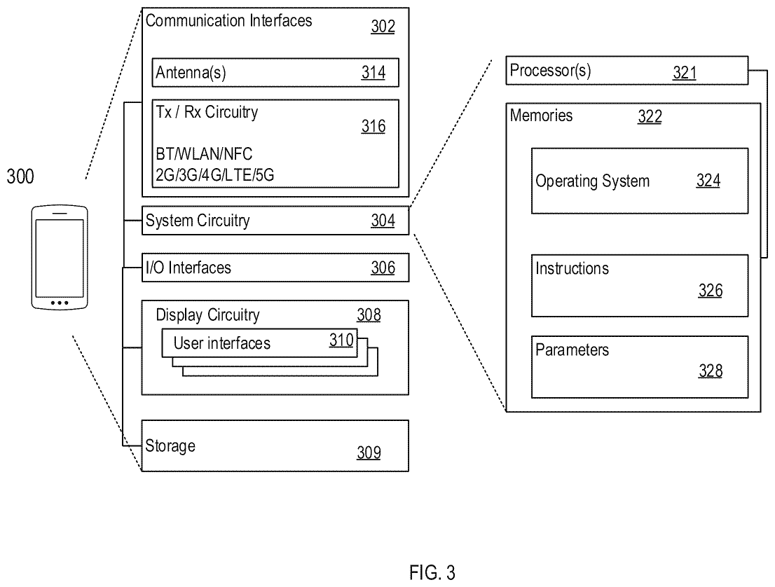

FIG. 3 shows an exemplary user equipment (UE) 300. The UE 300 may be a mobile device, for example, a smart phone or a mobile communication module disposed in a vehicle. The UE 300 may include communication interfaces 302, a system circuitry 304, an input/output interfaces (I/O) 306, a display circuitry 308, and a storage 309. The display circuitry may include a user interface 310. The system circuitry 304 may include any combination of hardware, software, firmware, or other logic/circuitry. The system circuitry 304 may be implemented, for example, with one or more systems on a chip (SoC), application specific integrated circuits (ASIC), discrete analog and digital circuits, and other circuitry. The system circuitry 304 may be a part of the implementation of any desired functionality in the UE 300. In that regard, the system circuitry 304 may include logic that facilitates, as examples, decoding and playing music and video, e.g., MP3, MP4, MPEG, AVI, FLAC, AC3, or WAV decoding and playback; running applications; accepting user inputs; saving and retrieving application data; establishing, maintaining, and terminating cellular phone calls or data connections for, as one example, internet connectivity; establishing, maintaining, and terminating wireless network connections, Bluetooth connections, or other connections; and displaying relevant information on the user interface 310. The user interface 310 and the inputs/output (I/O) interfaces 306 may include a graphical user interface, touch sensitive display, haptic feedback or other haptic output, voice or facial recognition inputs, buttons, switches, speakers and other user interface elements. Additional examples of the I/O interfaces 306 may include microphones, video and still image cameras, temperature sensors, vibration sensors, rotation and orientation sensors, headset and microphone input/output jacks, Universal Serial Bus (USB) connectors, memory card slots, radiation sensors (e.g., IR sensors), and other types of inputs.

Referring to FIG. 3, the communication interfaces 302 may include a Radio Frequency (RF) transmit (Tx) and receive (Rx) circuitry 316 which handles transmission and reception of signals through one or more antennas 314. The communication interface 302 may include one or more transceivers. The transceivers may be wireless transceivers that include modulation/demodulation circuitry, digital to analog converters (DACs), shaping tables, analog to digital converters (ADCs), filters, waveform shapers, filters, pre-amplifiers, power amplifiers and/or other logic for transmitting and receiving through one or more antennas, or (for some devices) through a physical (e.g., wireline) medium. The transmitted and received signals may adhere to any of a diverse array of formats, protocols, modulations (e.g., QPSK, 16-QAM, 64-QAM, or 256-QAM), frequency channels, bit rates, and encodings. As one specific example, the communication interfaces 302 may include transceivers that support transmission and reception under the 2G, 3G, BT, WiFi, Universal Mobile Telecommunications System (UMTS), High Speed Packet Access (HSPA)+, 4G/Long Term Evolution (LTE), and 5G standards. The techniques described below, however, are applicable to other wireless communications technologies whether arising from the 3rd Generation Partnership Project (3GPP), GSM Association, 3GPP2, IEEE, or other partnerships or standards bodies.

Referring to FIG. 3, the system circuitry 304 may include one or more processors 321 and memories 322. The memory 322 stores, for example, an operating system 324, instructions 326, and parameters 328. The processor 321 is configured to execute the instructions 326 to carry out desired functionality for the UE 300. The parameters 328 may provide and specify configuration and operating options for the instructions 326. The memory 322 may also store any BT, WiFi, 3G, 4G, 5G or other data that the UE 300 will send, or has received, through the communication interfaces 302. In various implementations, a system power for the UE 300 may be supplied by a power storage device, such as a battery or a transformer.

The present disclosure describes several embodiments of methods and devices for determining a target cell identifier (ID) for calculating a message authentication code for integrity (MAC-I), which may be implemented, partly or totally, on the wireless network base station and/or the user equipment described above in FIGS. 2 and 3.

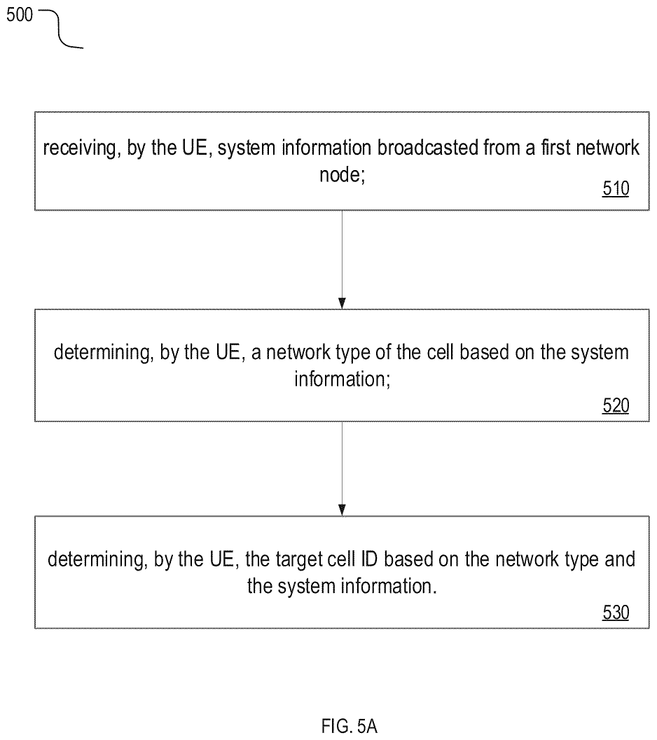

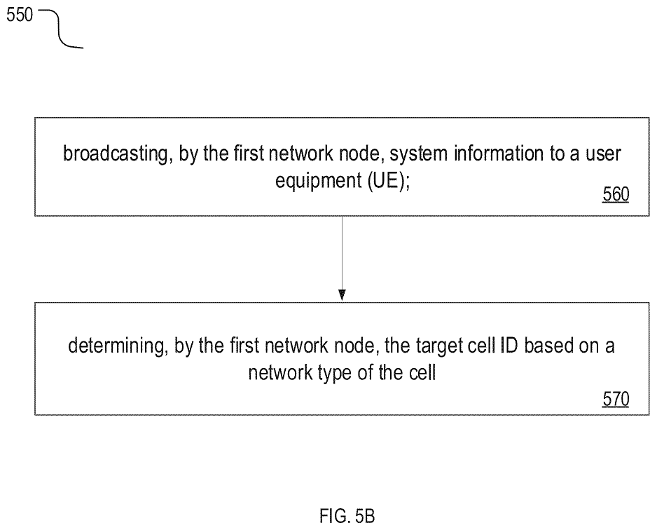

In various embodiments, FIG. 5A shows a flow diagram of a method 500 for wireless communication including determining, by a user equipment (UE), a target cell identity (ID) for calculating an authentication code corresponding to a cell. The method 500 may include a portion or all of the following steps: step 510, receiving, by the UE, system information broadcasted from a first network node; step 520, determining, by the UE, a network type of the cell based on the system information; and/or step 530, determining, by the UE, the target cell ID based on the network type and the system information.

In various embodiments, FIG. 5B shows a flow diagram of a method 550 for wireless communication including determining, by a first network node, a target cell identity (ID) for calculating an authentication code corresponding to a cell. The method 550 may include a portion or all of the following steps: step 560: broadcasting, by the first network node, system information to a user equipment (UE); and/or step 570, determining, by the first network node, the target cell ID based on a network type of the cell. In some implementations, step 570 may include determining, by the first network node, the target cell ID based on a network type of the cell and the system information.

In some implementations, in additional to a portion or a combination of the described implementations/embodiments, the authentication code comprises a message authentication code for integrity (MAC-I).

In some implementations, in additional to a portion or a combination of the described implementations/embodiments, the authentication code is used for one of a connection resume procedure or a connection reestablish procedure.

In some implementations, in additional to a portion or a combination of the described implementations/embodiments, the cell comprises one of the following: a cell with a first network type only, a cell with a second network type only, or a cell shared by the first network type and the second network type.

In some implementations, in additional to a portion or a combination of the described implementations/embodiments, the first network type is a public land mobile network (PLMN).

In some implementations, in additional to a portion or a combination of the described implementations/embodiments, the second network type is a non-public network (NPN).

In some implementations, in additional to a portion or a combination of the described implementations/embodiments, a cell with a second network type only is a NPN-only cell, comprising at least one of the following: a stand-along NPN (SNPN) only cell, a public network integrated-NPN (PNI-NPN) only cell, a NPN cell shared by SNPN and PNI-NPN.

In some implementations, in additional to a portion or a combination of the described implementations/embodiments, in response to the cell with the first network type only or the cell shared by the first and second network types, the network type of the cell is determined as the first network type.

In some implementations, in additional to a portion or a combination of the described implementations/embodiments, in response to the cell with the second network type only, the network type of the cell is determined as the second network type.

In some implementations, in additional to a portion or a combination of the described implementations/embodiments, in response to the network type of the cell being the first network type, a first cell ID in a first network type list is determined as the target cell ID, wherein the system information comprises a network ID list of the first network type. The first network type list may refer to a list of cells having the first network type. In the present disclosure, the “first” cell ID in the first network type list may refer to a cell ID of the “top” (or appearing “earliest” in the system information) cell in the first network type list, and may not merely refer to a cell ID of “any” cell in the first network type list.

In some implementations, in additional to a portion or a combination of the described implementations/embodiments, in response to the network type of the cell being the second network type, a first cell ID in a second network type list is determined as the target cell ID, wherein the system information comprises a network ID list of the second network type. The second network type list may refer to a list of cells having the second network type. In the present disclosure, the “first” cell ID in the second network type list may refer to a cell ID of the “top” (or appearing “earliest” in the system information) cell in the second network type list, and may not merely refer to a cell ID of “any” cell in the second network type list.

In some implementations, in additional to a portion or a combination of the described implementations/embodiments, the first network node sends a message to a second network node, which comprising the target cell ID.

In some implementations, in additional to a portion or a combination of the described implementations/embodiments, the second network node comprises a base station that last serves the UE.

The present disclosure describes various embodiments for determining a target cell ID for calculating a MAC-I, addressing at least one of the issues/problems with the existing wireless communication. One of the issues/problems may be described below. For a SNPN only cell, the network may broadcast a dummy PLMN to the legacy public network ID list. Similarly, for a PNI-NPN only cell, the network may broadcast a forbidden PLMN to the legacy public network ID list. In other words, the cell access information for the legacy public part may be invalid for the NPN-only cell. Thus, when the UE need to resume/reestablish the connection with the NPN-only cell, there may be some problems with taking the first cell ID of the PLMN network as the target cell ID.

Various embodiments in the present disclosure may include that, at a UE side, for the NPN-only cell, the UE may set the cell Identity of the first NPN that broadcast by the system information as the target cell ID for calculate the short MAC-I, wherein the short MAC-I may be the short MAC-I for the RRC connection resume or RRC connection reestablish; the NPN-only cell may be the SNPN only cell, PNI-NPN only cell or the cell shared by both the SNPN and PNI-NPN; and/or the first NPN may be SNPN or PNI-NPN.

Various embodiments in the present disclosure may include that, at a network side, for the NPN-only cell, the network may set the cell identity of the first NPN that is broadcasted by the system information as the target cell ID on the messages that sent between network nodes, wherein the NPN-only cell may be the SNPN only cell, PNI-NPN only cell or the cell shared by both the SNPN and PNI-NPN; and/or the first NPN can be SNPN or PNI-NPN.

In the present disclosure, the first NPN that is broadcasted by the system information may refer to a “top” NPN in the system information (or the “earliest” NPN broadcasted by the system information), and may not merely refer to “any” NPN that is broadcasted by the system information.

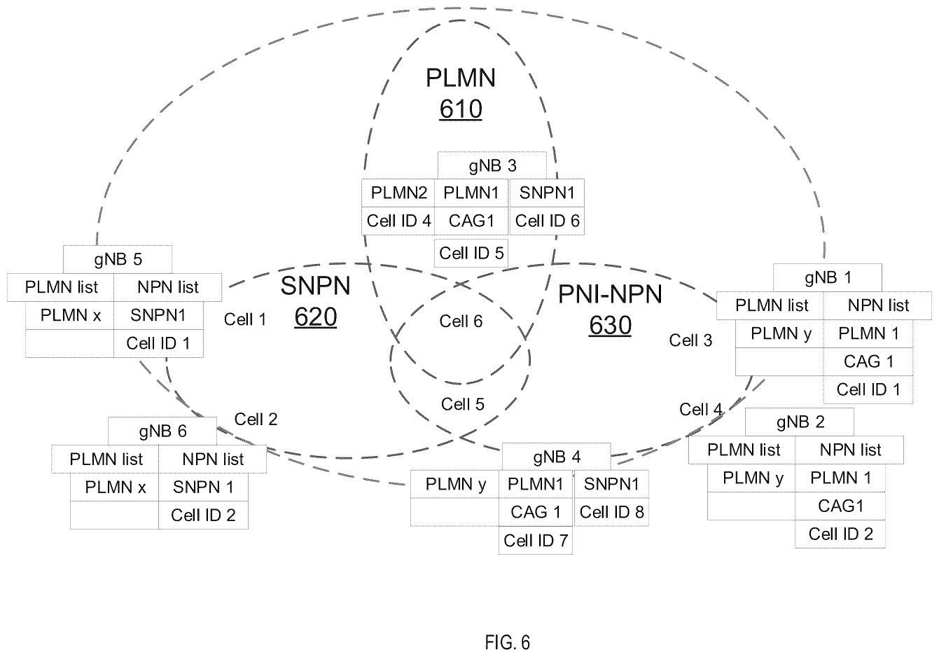

One non-limiting example includes network deployment with both NPN-only cell and non-NPN-only cell. Referring to FIG. 6, there are a PLMN network (610), a SNPN network (620), and a PNI-NPN network (630). There are some cells shared by one or more the above networks. For example, Cell 1 and Cell 2 are SNPN-only cells; the Cell 3 and Cell 4 are PNI-NPN only cells; Cell 5 is shared by the SNPN and PNI-NPN; Cell 6 is shared by the public network and the non-public network. Thus Cell 1, Cell 2, Cell 3, Cell 4, and Cell 5 are NPN only cells, and Cell 6 is not an NPN only cell.

In some implementations, the network deployment for Cell 1 to Cell 6 is shown in Table 1; and/or the system information broadcasting for each cell is shown in Table 2.

TABLE 1
Network Deployment

| Network Type | Cell ID | | | |
|---|---|---|---|---|
| PLMN1 + | Cell 3: Cell | Cell 4: Cell | Cell 5: Cell | Cell 6: Cell |
| CAG1 | ID 1 | ID 2 | ID 7 | ID 5 |
| PLMN2 | | | | Cell 6: Cell |
| | | | | ID 4 |
| SNPN 1 | Cell 1: Cell | Cell 2: Cell | Cell 5: Cell | Cell 6: Cell |
| | ID 1 | ID 2 | ID 8 | ID 6 |

TABLE 2
System Information Broadcasting for Each Cell

| Cell | PLMN list | NPN list | |
|---|---|---|---|
| Cell1 | PLMN x | SNPN1 Cell ID 1 | |
| Cell2 | PLMN x | SNPN1 Cell ID 2 | |
| Cell3 | PLMN y | PLMN1 CAG 1 Cell ID 1 | |
| Cell4 | PLMN y | PLMN1 CAG 1 Cell ID 2 | |
| Cell5 | PLMN y | PLMN1 CAG 1 Cell | SNPN1 Cell ID 8 |
| | | ID 7 | |
| Cell6 | PLMN2 Cell ID 4 | PLMN1 CAG 1 Cell | SNPN1 Cell ID 6 |
| | | ID 5 | |

Another non-limiting example shows mobility between the NPN-only cell and non-NPN-only cell. Based on the network/cell configuration and system information broadcasting for each cell as shown in FIG. 6, a SNPN UE may move among the Cell 1, Cell 2, Cell 5, and Cell 6; and a PNI-NPN UE may move among the Cell 3, Cell 4, Cell 5, and Cell 6.

How to determine the target cell ID may be described by giving examples for the following cases.

For Case 1: the target cell is the non-NPN only cell, e.g. cell 6, and then, the target cell ID may be determined as {PLMN2, Cell ID 4}. For example, considering Cell 6 is a non-NPN only cell, a first cell ID in the public network is determined as the target cell ID; and {PLMN2 Cell ID 4} is the “first” cell ID in the public network (actually the only one in the PLMN list for Cell 6, see Table 2). So, {PLMN2 Cell ID 4} is determined as the target cell ID.

For Case 2: the target cell is the NPN only cell, e.g. any cell of the Cell 1, Cell 2, and Cell 5.

For Case 2a: the target cell is the SNPN only cell, e.g. Cell 1 or Cell2, and then, the target cell ID may be determined as SNPN1 Cell ID 1 for the target cell being Cell 1, or the target cell ID may be determined as SNPN1 Cell ID 2 for the target cell being Cell 2. Taking Cell 1 as an example, considering Cell 1 is a SNPN only cell, a first cell ID in the SNPN list is determined as the target cell ID; and {SNPN1 Cell ID 1} is the “first” cell ID in the SNPN list (actually the only one in the SNPN list for Cell 1, see Table 2). So, {SNPN1 Cell ID 1} is determined as the target cell ID.

For Case 2b: the target cell is the NPN only cell but the first NPN ID is PNI-NPN, e.g., cell 5; and then, the target cell ID may be determined as PLMN1 Cell ID 7. Taking Cell 5 as an example, considering Cell 5 is a NPN only cell, a first cell ID in the first NPN is determined as the target cell ID; PNI-NPN is the “first” NPN ID in the NPN list (see Table 2); and {PLMN1 Cell ID 7} is the “first” cell ID in the PNI-NPN list (actually the only one in the PNI-NPN list for Cell 5, see Table 2). So, {PLMN1 Cell ID 7} is determined as the target cell ID.

For Case 3, for the PNI-NPN, the target cell is the non-NPN only cell, e.g., Cell 6, and then, the target cell ID may be determined as PLMN2 Cell ID 4.

For Case 4, for the PNI-NPN, the target cell is the NPN only cell, e.g., any one of Cell 3, Cell 4, and/or Cell 5. The target cell ID may be determined as PLMN1 Cell ID 7 for the target cell being Cell 5, the target cell ID may be determined as PLMN1 Cell ID 1 for the target cell being Cell 3; and/or the target cell ID may be determined as PLMN1 Cell ID 2 for the target cell being Cell 4.

At the UE side the UE may determine the target cell ID setting for each case to calculate the short MAC-I for resume or reestablish procedure.

At the network side, the gNB may determine the target cell ID setting for each case to calculate the short MAC-I for resume or reestablish procedure.

Another non-limiting example shows network side target ID setting. A target network (e.g., a target gNB) node may send a retrieve UE context request message to a source network node (e.g, a source gNB or last served gNB). The retrieve UE context request message may include a New Cell Identifier.

In some implementations, the network set the “New Cell Identifier” in the RETRIEVE UE CONTEXT REQUEST message in Table 3:

TABLE 3
Target cell ID setting

| Target cell ID for eachCell | Cell Type |
|---|---|
| Cell 6: PLMN2 Cell ID 4 | Non-NPN only cell, so set the target cell |
| | ID to the cell ID of the first PLMN |
| Cell 1: SNPN1 Cell ID 1 | NPN only cell, so set the target cell ID |
| Cell 2: SNPN1 Cell ID 2 | to the cell ID of the first NPN |
| Cell 3: PLMN1 Cell ID 1 | |
| Cell 4: PLMN1 Cell ID 2 | |
| Cell 5: PLMN1 Cell ID 7 | |

Another non-limiting example includes Asn.1 coding and field description for the short MAC I input at the UE side. Regarding VarResumeMAC-Input, the UE variable VarResumeMAC-Input specifies the input used to generate the resumeMAC-I during RRC Connection Resume procedure, and Asn.1 coding for the VarResumeMAC-Input variable as below.

| | |
|---|---|
| VarResumeMAC-Input ::= | SEQUENCE { |
| sourcePhysCellId | PhysCellId, |
| targetCellIdentity | CellIdentity, |
| source-c-RNTI | RNTI-Value |

}

In some implementations, the filed description for the VarResumeMAC-Input variable as below.

TargetCellIdentity: an input variable used to calculate the resumeMAC-I. For the non-NPN-only cell, set to the cellIdentity of the first PLMN-Identity included in the PLMN-IdentityInfoList broadcasted in SIB1 of the target cell i.e. the cell the UE is trying to resume. For the NPN-only cell, set to the cellIdentity of the first NPN identity in the NPN-IdentityInfoList broadcasted in SIB1 of the target cell i.e. the cell the UE is trying to resume.

Regarding VarShortMAC-Input, the UE variable VarShortMAC-Input specifies the input used to generate the shortMAC-I during RRC Connection Reestablishment procedure. The Asn.1 coding for the VarShortMAC-Input variable as below.

| | |
|---|---|
| VarShortMAC-Input ::= | SEQUENCE { |
| sourcePhysCellId | PhysCellId, |
| targetCellIdentity | CellIdentity, |
| source-c-RNTI | RNTI-Value |

}

In some implementations, the filed description for the VarShortMAC-Input variable as below.

TargetCellIdentity: an input variable used to calculate the shortMAC-I. For the non-NPN-only cell, set to the cellIdentity of the first PLMN-Identity in the PLMN-IdentityInfoList broadcasted in SIB1 of the target cell i.e. the cell the UE is trying to reestablish the connection. For the NPN-only cell, set to the cellIdentity of the first NPN identity in the NPN-IdentityInfoList broadcasted in SIB1 of the target cell i.e. the cell the UE is trying to reestablish the connection.

Another non-limiting example include enhancement to the SNPN and PNI-NPN sharing scenario. For the case that a cell is shared by the two different NPN network types, the UE may set the target cell ID to the first cell ID of the UE camped network Type. Taking the Cell 5 in FIG. 6 as an example, when a SNPN UE moves to Cell 5, the UE may set the SNPN1 Cell ID 8 as the target cell ID, according to Table 2.

In some implementations, at the network side, it may use the cell ID (e.g. PLMN1 Cell ID 7) of the first NPN ID of the first NPN network type (e.g., PNI-NPN) as the target cell ID. When the MAC-I check fails, the network may further take the cell ID (e.g. SNPN1 Cell ID 8) of the first NPN ID of the second NPN network type (e.g., SNPN) as the target cell ID.

In various implementations/embodiments described in the present disclosure, for the SNPN network ID, only the PLMN part may be used, such as a SNPN ID=PLMN+network ID (NID).

Below paragraphs describe Asn.1 coding and field description for the short MAC I input at the UE side with enhancement.

Regarding VarResumeMAC-Input, the UE variable VarResumeMAC-Input specifies the input used to generate the resumeMAC-I during RRC Connection Resume procedure. Asn.1 coding for the VarResumeMAC-Input variable as below.

| | |
|---|---|
| VarResumeMAC-Input ::= | SEQUENCE { |
| sourcePhysCellId | PhysCellId, |
| targetCellIdentity | CellIdentity, |
| source-c-RNTI | RNTI-Value |

}

In some implementations, the filed description for the VarResumeMAC-Input variable as below.

TargetCellIdentity: an input variable used to calculate the resumeMAC-I. For the non-NPN-only cell, set to the cellIdentity of the first PLMN-Identity included in the PLMN-IdentityInfoList broadcasted in SIB1 of the target cell i.e. the cell the UE is trying to resume. For the NPN-only cell, set to the cellIdentity of the first NPN identity (SNPN identity in case of SNPN, or PNI-NPN identity in case of PNI-NPN) in the NPN-IdentityInfoList broadcasted in SIB1 of the target cell i.e. the cell the UE is trying to resume.

Regarding VarShortMAC-Input, the UE variable VarShortMAC-Input specifies the input used to generate the shortMAC-I during RRC Connection Reestablishment procedure. The Asn.1 coding for the VarShortMAC-Input variable as below.

| | |
|---|---|
| VarShortMAC-Input ::= | SEQUENCE { |
| sourcePhysCellId | PhysCellId, |
| targetCellIdentity | CellIdentity, |
| source-c-RNTI | RNTI-Value |

}

In some implementations, the filed description for the VarShortMAC-Input variable as below.

TargetCellIdentity: an input variable used to calculate the shortMAC-I. For the non-NPN-only cell, set to the cellIdentity of the first PLMN-Identity in the PLMN-IdentityInfoList broadcasted in SIB1 of the target cell i.e. the cell the UE is trying to reestablish the connection. For the NPN-only cell, set to the cellIdentity of the first NPN identity (SNPN identity in case of SNPN, or PNI-NPN identity in case of PNI-NPN) in the NPN-IdentityInfoList broadcasted in SIB1 of the target cell i.e. the cell the UE is trying to reestablish the connection.

The present disclosure describes methods, apparatus, and computer-readable medium for wireless communication. The present disclosure addressed the issues with determining a target cell identifier (ID) for calculating a message authentication code for integrity (MAC-I). The methods, devices, and computer-readable medium described in the present disclosure may facilitate the performance of wireless communication by determining a target cell ID for calculating a MAC-I, thus improving efficiency and overall performance. The methods, devices, and computer-readable medium described in the present disclosure may improves the overall efficiency of the wireless communication systems.

Reference throughout this specification to features, advantages, or similar language does not imply that all of the features and advantages that may be realized with the present solution should be or are included in any single implementation thereof. Rather, language referring to the features and advantages is understood to mean that a specific feature, advantage, or characteristic described in connection with an embodiment is included in at least one embodiment of the present solution.

Thus, discussions of the features and advantages, and similar language, throughout the specification may, but do not necessarily, refer to the same embodiment.

Furthermore, the described features, advantages and characteristics of the present solution may be combined in any suitable manner in one or more embodiments. One of ordinary skill in the relevant art will recognize, in light of the description herein, that the present solution can be practiced without one or more of the specific features or advantages of a particular embodiment. In other instances, additional features and advantages may be recognized in certain embodiments that may not be present in all embodiments of the present solution.

1. A method for wireless communication, comprising:
determining, by a user equipment (UE), a target cell identity (ID) for calculating an authentication code corresponding to a cell, by:
receiving, by the UE, system information broadcasted from a first network node;
determining, by the UE, a network type of the cell based on the system information; and
determining, by the UE, the target cell ID based on the network type and the system information.

2. A method for wireless communication, comprising:
determining, by a first network node, a target cell identity (ID) for calculating an authentication code corresponding to a cell, by:
broadcasting, by the first network node, system information to a user equipment (UE); and
determining, by the first network node, the target cell ID based on a network type of the cell.

3. The method according to claim 1, wherein:
the authentication code comprises a message authentication code for integrity (MAC-I).

4. The method according claim 3, wherein:
the authentication code is used for one of a connection resume procedure or a connection reestablish procedure.

5. The method according to claim 1, wherein:
the cell comprises one of the following: a cell with a first network type only, a cell with a second network type only, or a cell shared by the first network type and the second network type.

6. The method according to claim 5, wherein:
the first network type is a public land mobile network (PLMN).

7. The method according to claim 5, wherein:
the second network type is a non-public network (NPN).

8. The method according to claim 5, wherein:
a cell with a second network type only is an NPN-only cell, comprising at least one of the following: a stand-along NPN (SNPN) only cell, a public network integrated-NPN (PNI-NPN) only cell, an NPN cell shared by SNPN and PNI-NPN.

9. The method according to claim 5:
in response to the cell with the first network type only or the cell shared by the first and second network types, the network type of the cell is determined as the first network type.

10. The method according to claim 5:
in response to the cell with the second network type only, the network type of the cell is determined as the second network type.

11. The method according to claim 1, wherein:
in response to the network type of the cell being the first network type, a first cell ID in a first network type list is determined as the target cell ID, wherein the system information comprises a network ID list of the first network type.

12. The method according to claim 1, wherein:
in response to the network type of the cell being the second network type, a first cell ID in a second network type list is determined as the target cell ID, wherein the system information comprises a network ID list of the second network type.

13. The method according to claim 1, wherein:
the first network node sends a message to a second network node, which comprising the target cell ID.

14. The method according to claim 13, wherein:
the second network node comprises a base station that last serves the UE.

15. A wireless communications apparatus comprising a processor and a memory, wherein the processor is configured to read code from the memory and implement a method recited in claim 1.

16. A computer program product comprising a computer-readable program medium code stored thereupon, the computer-readable program medium code, when executed by a processor, causing the processor to implement a method recited in claim 1.

17. The method according to claim 2, wherein:
the authentication code comprises a message authentication code for integrity (MAC-I).

18. The method according to claim 2, wherein:
the cell comprises one of the following: a cell with a first network type only, a cell with a second network type only, or a cell shared by the first network type and the second network type.

19. The method according to claim 2, wherein:
in response to the network type of the cell being the first network type, a first cell ID in a first network type list is determined as the target cell ID, wherein the system information comprises a network ID list of the first network type.

20. The method according to claim 3, wherein:
in response to the network type of the cell being the first network type, a first cell ID in a first network type list is determined as the target cell ID, wherein the system information comprises a network ID list of the first network type.
